(19) United States
(12) Patent Application Publication
(10) Pub. No.: US 2026/0311629 A1
(43) Pub. Date: Oct. 8, 2026

(54) APPARATUS AND METHOD FOR DETERMINING OPTIMAL ADAPTIVE SYNCHRONIZATION FRAME RANGE FROM AMONG MULTIPLE ADAPTIVE SYNCHRONIZATION FRAME RANGES

(71) Applicant: LG Electronics Inc., Seoul (KR)

(72) Inventors: Seunghyun YOO, Seoul (KR); Dokyun KIM, Seoul (KR)

(21) Appl. No.: 19/476,372

(22) PCT Filed: Apr. 18, 2024
(86) PCT No.: PCT/KR2024/005249

§ 371 Date: Oct. 17, 2025

(30) Foreign Application Priority Data
Apr. 18, 2023 (KR) 10-2023-0050609

(51) Int. Cl. G09G 3/20; G06F 3/14

(52) U.S. Cl. CPC G09G 3/2096; G06F 3/14; G09G 2320/0247; G09G 2320/0252; G09G 2320/0257; G09G 2320/0261; G09G 2340/0435; G09G 2370/042; G09G 2370/22

(57) ABSTRACT

According to various embodiments of the present disclosure, there is provided a method of operating a source device. The method includes receiving a hot plug detection (HPD) signal from a sink device; receiving extended display identification (EDID) and DisplayID from the sink device; determining an adaptive-Sync data block and a frame rate based on the EDID and the DisplayID of the sink device; and transmitting a session description protocol (SDP) generated based on the determined adaptive-Sync data block, and information of the determined frame rate to the sink device.

### TECHNICAL FIELD

The present disclosure relates to a device and method for performing an adaptive synchronization (Sync) operation. More specifically, the present disclosure relates to a device and method for determining an optimal adaptive-Sync frame range among multiple adaptive-Sync frame ranges.

### BACKGROUND ART

The Display Port standard limits a transfer rate based on supported resolutions and whether to use display stream compression (DSC), and thus an adaptive-Sync frame range differently operates in response to this. Accordingly, a multi-frame adaptive-Sync range shall be written in EDID, and proper rules are required for correct operation. However, no appropriate rules for operating multi-frame adaptive-Sync have been defined to date.

When the adaptive-Sync frame range is set from 60 Hz to 240 Hz, an adaptive-Sync mode operates at 120 Hz not 240 Hz, which is a max frame range. If OverDrive is tuned to 240 Hz, excessive Over/Undershoot may occur when the adaptive-Sync mode operates at 120 Hz which is not tuned. When the OverDrive tuning based on the frame range is performed in a sink device (e.g., monitor) applying the adaptive-Sync technology, the tuning is performed based on the max frame range. Because the tuning is not performed at frequencies lower than the max frame range (the tuning is performed only in the max frame range), excessive Over/Undershoot occurs, leading to a problem.

Therefore, standardized regulations are required between a source device and the sink device that refer to only the max value of the frame range, so that the multi-frame adaptive-Sync properly operates. If this standardization is achieved, an adaptive-Sync-supporting device can automatically configure multi-frame adaptive-Sync and achieve optimal performance.

### DISCLOSURE

### Technical Problem

In order to solve the above-described problems, the present disclosure provides a device and method for performing an adaptive-Sync operation.

The present disclosure also provides a device and method for determining an optimal adaptive-Sync frame range among multiple adaptive-Sync frame ranges.

The technical objects to be achieved by the present disclosure are not limited to those that have been described hereinabove merely by way of example, and other technical objects that are not mentioned can be clearly understood by those skilled in the art, to which the present disclosure pertains, from the following descriptions.

### Technical Solution

According to various embodiments of the present disclosure, there is provided a method of operating a source device comprising receiving a hot plug detection (HPD) signal from a sink device; receiving first information related to an extended display identification (EDID) or a DisplayID (DPID) from the sink device; determining a specific video timing frame rate based on a plurality of video timing frame rates included in the first information of the sink device; based on an adaptive-Sync data block included in the first information being related to a plurality of adaptive-Sync frame ranges, determining a specific adaptive-Sync frame range, of which a maximum frame rate is related to the specific video timing frame rate, among the plurality of adaptive-Sync frame ranges; and transmitting processed information based on the specific adaptive-Sync frame range to the sink device.

According to various embodiments of the present disclosure, there is provided a source device comprising a processor, a memory; and a transceiver. The memory stores instructions performing operations based on being executed by the processor. The operations comprise receiving a hot plug detection (HPD) signal from a sink device; receiving first information related to an extended display identification (EDID) or a DisplayID (DPID) from the sink device; determining a specific video timing frame rate based on a plurality of video timing frame rates included in the first information of the sink device; based on an adaptive-Sync data block included in the first information being related to a plurality of adaptive-Sync frame ranges, determining a specific adaptive-Sync frame range, of which a maximum frame rate is related to the specific video timing frame rate, among the plurality of adaptive-Sync frame ranges; and transmitting processed information based on the specific adaptive-Sync frame range to the sink device.

According to various embodiments of the present disclosure, there are provided one or more non-transitory computer readable mediums storing one or more instructions. The one or more instructions perform operations based on being executed by one or more processors. The operations comprise receiving a hot plug detection (HPD) signal from a sink device; receiving first information related to an extended display identification (EDID) or a Display ID (DPID) from the sink device; determining a specific video timing frame rate based on a plurality of video timing frame rates included in the first information of the sink device; based on an adaptive-Sync data block included in the first information being related to a plurality of adaptive-Sync frame ranges, determining a specific adaptive-Sync frame range, of which a maximum frame rate is related to the specific video timing frame rate, among the plurality of adaptive-Sync frame ranges; and transmitting processed information based on the specific adaptive-Sync frame range to the sink device.

### Advantageous Effects

In order to solve the above-described problems, the present disclosure can provide a device and method for performing an adaptive-Sync operation.

The present disclosure can also provide a device and method for determining an optimal adaptive-Sync frame range among multiple adaptive-Sync frame ranges.

### DESCRIPTION OF DRAWINGS

The accompanying drawings, which are included to provide a further understanding of the present disclosure and constitute a part of the detailed description, illustrate embodiments of the present disclosure and serve to explain technical features of the present disclosure together with the description. Technical features of the present disclosure are not limited to specific drawings, and features disclosed in each drawing can be combined with each other to form a new embodiment. Reference numerals in each drawing may denote structural elements.

FIG. 1 is a block diagram illustrating a system according to various embodiments of the present disclosure.

FIG. 2 illustrates an example of Adaptive-Sync SDP transmission timing according to various embodiments of the present disclosure.

FIG. 3 illustrates an example of an AUX flowchart related to an Adaptive-Sync operation according to various embodiments of the present disclosure.

FIG. 4 illustrates an example of a structure of an Adaptive-Sync Data Block in DisplayID 2.0 according to various embodiments of the present disclosure.

FIG. 5 illustrates an example of a process for determining a frame range when a source device performs Adaptive-Sync operation.

FIG. 6 illustrates an example of a process for determining a frame range when a source device according to various embodiments of the present disclosure performs Adaptive-Sync operation.

FIG. 7 illustrates an example of an operation method of a source device according to various embodiments of the present disclosure.

### MODE FOR INVENTION

In various embodiments of the present disclosure, “A or B” may mean “only A,” “only B” or “both A and B.” In other words, in various embodiments of the present disclosure, “A or B” may be interpreted as “A and/or B.” For example, in various embodiments of the present disclosure, “A, B or C” may mean “only A,” “only B,” “only C” or “any combination of A, B and C.”

A slash (/) or comma used in various embodiments of the present disclosure may mean “and/or.” For example, “A/B” may mean “A and/or B.” Hence, “A/B” may mean “only A,” “only B” or “both A and B.” For example, “A, B, C” may mean “A, B, or C.”

In various embodiments of the present disclosure, “at least one of A and B” may mean “only A,” “only B” or “both A and B.” In addition, in various embodiments of the present disclosure, the expression of “at least one of A or B” or “at least one of A and/or B” may be interpreted in the same meaning as “at least one of A and B.”

Further, in various embodiments of the present disclosure, “at least one of A, B, and C” may mean “only A,” “only B,” “only C” or “any combination of A, B and C.” In addition, “at least one of A, B or C” or “at least one of A, B and/or C” may mean “at least one of A, B, and C.”

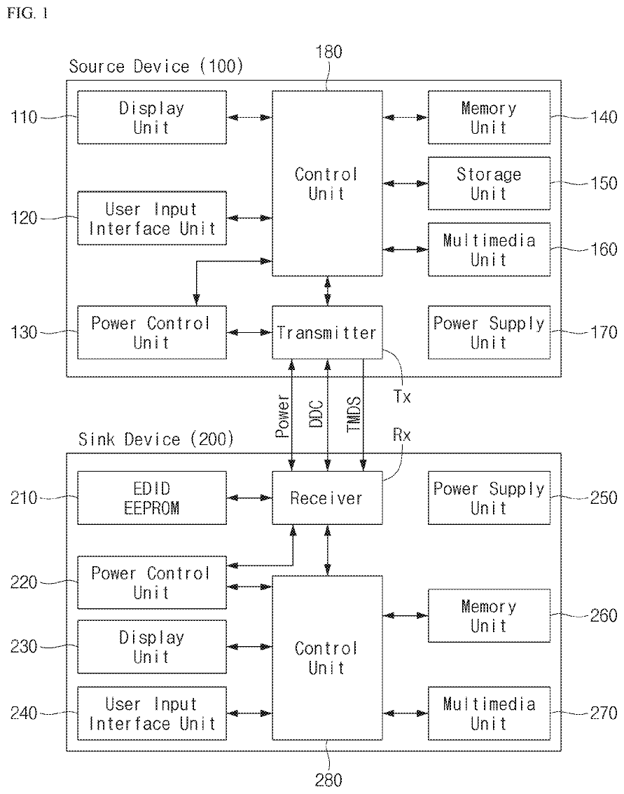

FIG. 1 is a block diagram illustrating a system according to various embodiments of the present disclosure.

Hereinafter, devices transmitting and receiving video/audio/control data are collectively referred to as AV (audio/video) systems. Examples of the AV systems include HDMI and DisplayPort.

Referring to FIG. 1, the AV system may include a source device 100 and a sink device 200. In particular, in an AV system, a device that transmits video/audio data may correspond to the source device 100, and a device that receives video/audio data may correspond to the sink device 200. In this case, a cable and connectors may be provided as a physical device that supports the transmission and reception of data by connecting the two devices.

The cables and the connectors may perform the pairing of four channels that provides a Transition Minimized Differential Signaling (TMDS) data channel and a TMDS clock channel. The TMDS data channels may be used to forward video data, audio data and auxiliary data.

Additionally, the AV system provides a Video Electronics Standards Association (VESA) Display Data Channel (DDD). The DDC is used for the configuration of a source device and a sink device and the exchange of status information between them. A CEC protocol can provide a high-level control function among various audio-visual products in a user environment and may be used optionally. Also, an optional HDMI Ethernet and Audio Return Channel (HEAC) may provide Ethernet-compatible data networking among an Audio Return Channel (ARC) and connected devices in the opposite direction from a TMDS.

Video data, audio data and supplementary data may be transmitted and received through three TDMS data channels. Commonly, a TMDS clock runs a video pixel rate, and is transmitted through a TMDS clock channel. The TMDS clock may be used as a reference frequency for data recovery in three TMDS data channels in a receiver. In a source device, the data of 8 bits per TMDS data channel may be transformed into a sequence of 10 bits of which transition is minimized, which is DC balanced, and transmitted in a serial manner at the rate of 10 bits per TMDS clock period.

In order to transmit audio data and supplementary data through the TMDS channel, the AV system uses a packet structure. In order to attain high reliability for audio data and control data, data may be transmitted in word of 10 bits which is generated by using a BCH error correction code and an error reduction coding.

The source device can figure out configuration information and available functions of the sink device by reading out Enhanced Extended Display Identification Data (E-EDID) of the sink device in the Display Data Channel (DDC). In what follows, the E-EDID may be called EDID information.

A utility line can be used for an optional extension function such as HEAC.

The source device 100 may receive Extended Display Identification Data (EDID) information from the sink device 200 through the DDC channel. The source device 100 may recognize the configuration information and support function of the sink device 200 by parsing the received EDID information. The EDID information may include at least one block including a variety of pieces of information about the sink device 200.

In particular, the EDID information according to an embodiment of the present invention may include information about the function and power supply ability of the sink device 200 in the transmission and reception of power. The source device 100 may recognize the power transmission/reception ability of the sink device 200 through such EDID information, and thus may transmit power to the sink device 200 or receive power from the sink device 200.

The source device 100 includes at least one of a display unit 110, a user input interface unit 120, a control unit 180, a transmitter Tx, a memory unit 140, a storage unit 150, a multimedia unit 160, a power control unit 130, and a power supply unit 170.

The sink device 200 includes at least one of EDID EEPROM 210, a power control unit 220, a display unit 230, a user input interface unit 240, a receiver Rx, a control unit 280, a power supply unit 250, a memory unit 260, and a multimedia unit 270. A unit that performs the same operation is not redundantly described.

The source device 100 is indicative of a physical device that transmits or streams content, stored in the storage unit 150, to the sink device 200. The source device 100 may transmit a request message to the sink device 200 or may receive and process a request message received from the sink device 200. The source device 100 may provide a User Interface (UI) through which a response message transmitted by the sink device 200 in response to a received request message is processed and delivered to a user. If the source device 100 includes the display unit 110, it may provide the UI in the form of a display. Furthermore, the source device 100 may require the supply of power from the sink device 200.

The sink device 200 may receive content from the source device 100, may transmit a request message to the source device 100 or process a message received from the source device 100, and may transmit a response message. The sink device 200 may provide a UI through which a response message received from the source device 100 is processed and delivered to a user. If the sink device 200 includes the display unit 230, it may provide the UI in the form of a display. Furthermore, the sink device 200 may supply the source device 100 with power requested by the source device 100.

The user input interface unit 120, 240 may receive a user's action or input. In an embodiment, the user input interface 120, 240 may correspond to a remote controller, a voice reception/recognition device or a touch input sensing/reception device.

The control unit 180, 280 may control an overall operation of each device. In particular, the control unit 180, 280 may perform communication between the units of each device and control the operation of each unit.

The memory unit 140, 260 is indicative of a volatile physical device in which various types of data are temporarily stored.

The storage unit 150 is indicative of a non-volatile physical device capable of storing various types of data.

The EDID EEPROM 210 is indicative of EEPROM in which EDID information is stored.

All of the memory unit 140, 260, the storage unit 150, and the EDID EEPROM 210 function to store data, and they may be collectively called a memory unit.

The display unit 110, 230 may display data or content received, data and a UI stored in the memory unit, etc. under the control of the control unit 180, 280.

The multimedia unit 160, 270 may play back various types of multimedia. The multimedia unit 160, 270 may be implemented independently of the control unit 180, 280 or may be implemented as a single physical element along with the control unit 180, 280.

The power supply unit 170, 250 may supply power for the operations of the source device 100, the sink device 200, and the units of the source device 100 and the sink device 200.

The transmitter Tx is a unit included in the source device 100 and configured to transmit and receive data. The transmitter Tx performs the transmission and reception of data including messages, such as commands, requests and responses between the devices, in addition to audio/video data.

The receiver Rx is a unit included in the sink device 200 and configured to transmit and receive data. The receiver Rx performs the transmission and reception of data including messages, such as commands, requests or responses between the devices, in addition to audio/video data.

The power control unit 130, 220 may manage and control the transmission and reception of power between the devices through the transmitter and the receiver.

Units of the aforementioned units other than the transmitter Rx, the receiver Tx, and the control unit 180, 280 may be optionally included in the source device 100 or the sink device 200 according to an embodiment, and may not correspond to essential element units.

In a conventional technology, in an AV system, the transmission of power between a source device and a sink device is not supported. As a result, if a portable device is driven for a long time, a user feels inconvenient because he or she has to always connect an external power cable for optimum driving. In order to solve such inconvenience, this specification proposes a method for guaranteeing optimum driving of an AV system without an external separate device in such a manner that a wired interface supports a power transfer function in the AV system.

For convenience of a description hereunder, a device that supplies (or transmits) power is called a “PSource device”, and a device that is supplied with (or receives) power is called a “PSink device.” Furthermore, a device that simultaneously supports the functions of the PSource device and the PSink device is called a “dual device.”

### BACKGROUND ON VARIOUS EMBODIMENTS OF THE PRESENT DISCLOSURE

### Adaptive-Sync Operation

Adaptive-Sync is a technology used in the field of computer graphics that synchronizes graphics card and monitor to eliminate screen flickering and tearing. The adaptive-Sync is a standardized technology of DisplayPort Adaptive-Sync technology and HDMI variable refresh rate (VRR) technology by Video Electronics Standards Association (VESA).

The adaptive-Sync technology includes a communication protocol for communication between the graphics card and the monitor, and time-splitting technology for synchronization between the graphics card and the monitor, or the like. Therefore, the Adaptive-Sync technology includes the following technical fields.
Graphics Card Technology: The graphics card shall support a variable refresh rate (VRR) technology to support the Adaptive-Sync. AMD provides FreeSync, and NVIDIA provides G-Sync, each with its own VRR technology.
Communication Protocol Technology: Display connection interface supporting the Adaptive-Sync requires Display Port 1.2a or higher and HDMI 2.1 or higher. Further, the graphics card and the monitor shall use the same communication protocol to use the Adaptive-Sync.
Monitor Technology: A monitor supporting the Adaptive-Sync shall support VRR technology of the graphics card. Further, the monitor supporting the Adaptive-Sync shall support a communication protocol with the graphics card.
Time-sharing Technology: The Adaptive-Sync uses time-sharing technology to synchronize the monitor and the graphics card. To this end, the graphics card and the monitor shall use the same time-sharing technology.

The Adaptive-Sync technology encompasses various fields of technologies, including graphics cards, communication protocols, monitors, and time-sharing technology, etc. These technologies work together to make the Adaptive-Sync possible.

### Source Device Operation During Live Frame Transmission

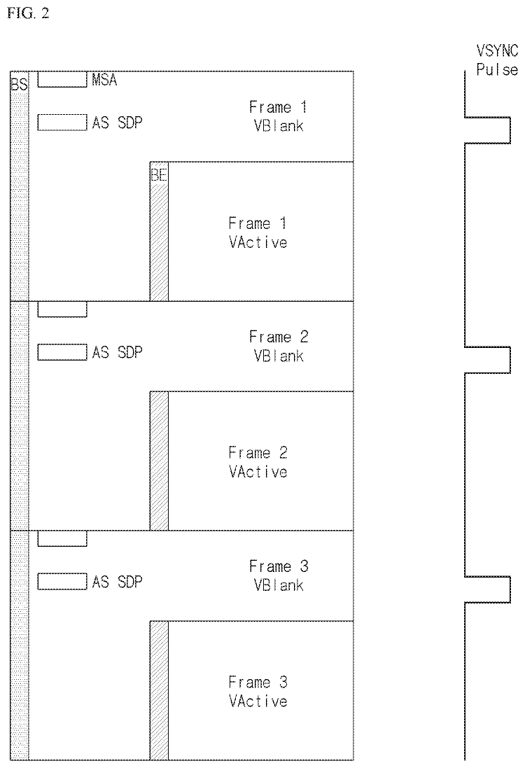

A source device that has set both the Source Device Enables Panel Replay Mode in Sink Device bitin the PANEL REPLAY ENABLE register (DPCD 001B0h[0]=1) and ALPM Enable bit in the RECEIVER_ALPM_CONFIGURATION register (DPCD 00116h[0]=1) shall transmit the Adaptive-Sync SDP at the VBlank line that corresponds to either of the following:
(1) The VSync pulse's leading edge, -or-
(2) One line before the VSync pulse's leading edge, starting with the first video frame, as illustrated in FIG. 2-155

When a Source device has not set both bits (DPCD 001B0h[0]=0 and/or DPCD 00116h[0]=0), the Source device may transmit at the line specified above -or- earlier during the VBlank period.

### Source Device Operation During Live Frame Transmission

A source device that has set both the Source Device Enables Panel Replay Mode in Sink Device bitin the PANEL REPLAY ENABLE register (DPCD 001B0h[0]=1) and ALPM Enable bit in the RECEIVER_ALPM_CONFIGURATION register (DPCD 00116h[0]=1) shall transmit the Adaptive-Sync SDP at the VBlank line that corresponds to either of the following:
(1) The VSync pulse's leading edge, -or-
(2) One line before the VSync pulse's leading edge, starting with the first video frame, as illustrated in FIG. 2-155

When a Source device has not set both bits (DPCD 001B0h[0]=0 and/or DPCD 00116h[0]=0), the Source device may transmit at the line specified above -or- earlier during the VBlank period.

FIG. 2 illustrates an example of Adaptive-Sync SDP transmission timing according to various embodiments of the present disclosure.

As for whether to transmit the Adaptive-Sync SDP on the VSync pulse's leading edge or one line earlier, the following mandates apply for the Source device:
(1) When the Sink device's DPCD 02214h[1]=0, the Source device shall keep DPCD 0011Bh[7]=0 and transmit the Adaptive-Sync SDP in the first half line -or- the first 3,840 pixel cycles, whichever comes first, on the line that corresponds to the VSync pulse's leading edge
(2) When the Sink device's DPCD 02214h[1]=1, the Source device may perform either of the following:
(3) Set DPCD 0011Bb[7]=1 during video mode set, and then transmit the entire Adaptive-Sync SDP one line earlier, at any time during the line, -or-
(4) Clear DPCD 0011Bb[7]=0 during video mode set, and then transmit the Adaptive-Sync SDP in the first half line -or- the first 1,920 pixel cycles, whichever comes first, on the line that corresponds to the VSync pulse's leading edge

As for whether to transmit the Adaptive-Sync SDP on the VSync pulse's leading edge or one line earlier, the following mandates apply for the Source device:
(1) When the Sink device's DPCD 02214h[1]=0, the Source device shall keep DPCD 0011Bh[7]=0 and transmit the Adaptive-Sync SDP in the first half line -or- the first 3,840 pixel cycles, whichever comes first, on the line that corresponds to the VSync pulse's leading edge
(2) When the Sink device's DPCD 02214h[1]=1, the Source device may perform either of the following:
(3) Set DPCD 0011Bb[7]=1 during video mode set, and then transmit the entire Adaptive-Sync SDP one line earlier, at any time during the line, -or-
(4) Clear DPCD 0011Bb[7]=0 during video mode set, and then transmit the Adaptive-Sync SDP in the first half line -or- the first 1,920 pixel cycles, whichever comes first, on the line that corresponds to the VSync pulse's leading edge

### Adaptive-Sync Operation AUX Flowchart

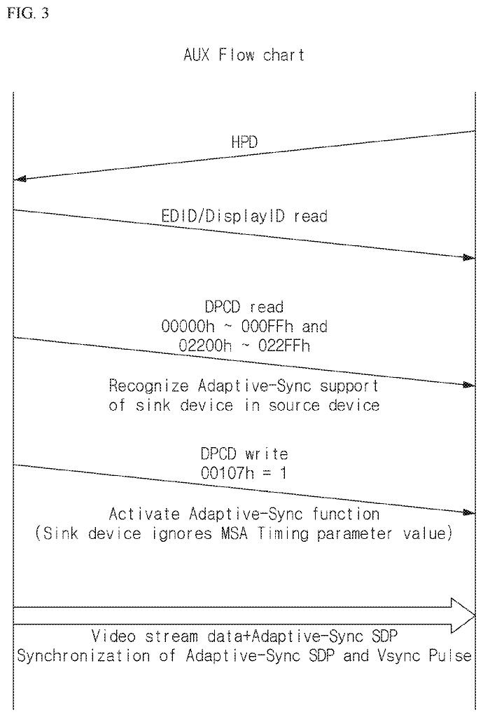

FIG. 3 illustrates an example of an AUX flowchart related to an Adaptive-Sync operation according to various embodiments of the present disclosure.

Referring to FIG. 3, a source device receives a hot plug detection (HPD) signal from a sink device.

The source device reads EDID/DisplayID (EDID/DisplayID Read) of the sink device. That is, the source device receives the EDID/DisplayID of the sink device from the sink device.

The source device reads DisplayPort Configuration Data (DPCD) of the sink device. The DPCD corresponds to 00000h-000FFh and 02200h-022FFh. The source device may determine whether the sink device supports the Adaptive-Sync through the DPCD.

The source device writes 00107h=1 to the DPCD and transmits the DPCD to the sink device. The source device enables an Adaptive-Sync capability by writing 00107h=1 to the DPCD. The sink device ignores a MSA timing parameter value.

On the assumption of the activation of the Adaptive-Sync, the source device transmits video stream data and Adaptive-Sync SDP to the sink device. The Adaptive-Sync SDP and Vsync Pulse are synchronized.

### Adaptive-Sync Operation Related DPCD

A DisplayPort Configuration Data Channel (DPCD) is part of a DisplayPort connection interface and is a data channel for communication between a sink device (e.g., monitor) and a source device (e.g., GPU). DP DPCD is used by the source device (e.g., GPU) to recognize the sink device (e.g., monitor), configure capability of the sink device (e.g., monitor), and share a DP connection state with the sink device (e.g., monitor). The configuration related to Adaptive-Sync DPCD operation is as follows.

### (1) Source Device Adaptive-Sync Operation Mandates

This section defines source device mandates for the following Adaptive-Sync policies:
(1-1) Before and during a video mode set
(1-2) During live frame transmission

Before performing a video mode configuration operation, the source device shall vertify the following:
(1-3) Stream sink in the connected sink device meets the following VESA AdaptiveSync mandates:
(1-3-1) Support the DisplayID Adaptive-Sync data block
(1-3-2) Support the CVT v2.0 RB v3 timing -or- detailed timing with 350-ppm offset exposed in the DisplayID
(1-4) DPRX in the connected sink device meets the VESA AdaptiveSync mandates.
(1-4-1) DPCD 00007h[6]=1 and DPCD 02207h[6]=1
(1-4-2) DPCD 02214h[0]=1

### (1) Source Device Adaptive-Sync Operation Mandates

This section defines Source device mandates for the following Adaptive-Sync policies:
(1-1) Before and during video mode set
(1-2) During live frame transmission

Before video mode set operation, a Source device shall verify the following:
(1-3) Stream Sink in the connected Sink device meets the following VESA AdaptiveSync mandates:
(1-3-1) Supports the DisplayID Adaptive-Sync data block
(1-3-2) Supports the CVT v2.0 RB v3 timing -or- detailed timing with 350-ppm offset exposed in the Display ID
(1-4) DPRX in the connected Sink device meets the VESA AdaptiveSync mandates:
(1-4-1) DPCD 00007h[6]=1 and DPCD 02207h[6]=1
(1-4-2) DPCD 02214h[0]=1

### (2) Sink Device Adaptive-Sync Operation Mandates

This section defines Sink device mandates for the following Adaptive-Sync policies:
(2-1) Before and during a video mode set
(2-2) During live frame transmission

VESA AdaptiveSync Sink device shall meet:
(2-3) Support the DisplayID Adaptive-Sync data block
(2-4) Support the CVT v2.0 RB v3 timing -or- detailed timing with 350-ppm offset exposed in the DisplayID
(2-5) Support Adaptive-Sync SDP v2 (HB2[4:0]=02h)
(2-6) Set the following Adaptive-Sync DPCD capability register bits as default:
(2-6-1) DPCD 00007h[6]=1 and DPCD 02207h[6]=1
(2-6-2) DPCD 02214h[0]=1
(2-7) Set DPCD 02214h[1]=1, as needed
(2-8) Arm for Adaptive-Sync operation when a source device writes DPCD 00107h[7]=1 during video mode set
(2-9) The sink device shall check for the presence of an Adaptive-Sync SDP as the Sink device starts receiving a video stream after video mode set operation because the Sink device may be connected to a legacy Source device that sets DPCD 00107h[7]=1 but does not transmit an Adaptive-Sync SDP. A VESA AdaptiveSync Sink device shall parse Adaptive-Sync SDP payload data bytes and display an image within a latency limit while meeting Adaptive-Sync Display CTS visual performance mandates (e.g., flicker performance of −50 dB or better, a responsive gray-to-gray transition without causing panel overdrive compensation ghosting), as long as both of the following conditions are met:
(2-10) The source device honors the sink device's frame duration increase and decrease Limits that are enumerated in the Adaptive-Sync data block (Bytes 1 and 5, respectively)
(2-11) Adaptive-Sync SDP payload content is true. The VESA AdaptiveSync Sink device shall also meet the minimum visual performance mandates (e.g., a flicker performance of −45 dB) as long as the Source device honors the minimum-to-maximum refresh range even when the Adaptive-Sync SDP payload content is false for one frame during an Adaptive-Sync operation mode transition.

### (2) Sink Device Adaptive-Sync Operation Mandates

This section defines Sink device mandates for the following Adaptive-Sync policies:
(2-1) Before and during video mode set
(2-2) During live frame transmission

A VESA AdaptiveSync Sink device shall:
(2-3) Support the Display ID Adaptive-Sync data block
(2-4) Support the CVT v2.0 RB v3 timing -or- detailed timing with 350-ppm offset exposed in the Display ID
(2-5) Support Adaptive-Sync SDP v2 (HB2[4:0]=02h)
(2-6) Set the following Adaptive-Sync DPCD capability register bits as default:
(2-6-1) DPCD 00007h[6]=1 and DPCD 02207h[6]=1
(2-6-2) DPCD 02214h[0]=1
(2-7) Set DPCD 02214h[1]=1, as needed
(2-8) Arm for Adaptive-Sync operation when a Source device writes DPCD 00107h[7]=1 during video mode set
(2-9) Sink device shall check for the presence of an Adaptive-Sync SDP as the Sink device starts receiving a video stream after video mode set operation because the Sink device may be connected to a legacy Source device that sets DPCD 00107h[7]=1 but does not transmit an Adaptive-Sync SDP A VESA AdaptiveSync Sink device shall parse Adaptive-Sync SDP payload data bytes and display an image within a latency limit while meeting Adaptive-Sync Display CTS visual performance mandates (e.g., flicker performance of −50 dB or better, a responsive gray-to-gray transition without causing panel overdrive compensation ghosting), as long as both of the following conditions are met:
(2-10) Source device honors the Sink device's Frame Duration Increase and Decrease Limits that are enumerated in the Adaptive-Sync data block (Bytes 1 and 5, respectively)
(2-11) Adaptive-Sync SDP payload content is true

The VESA AdaptiveSync Sink device shall also meet the minimum visual performance mandates (e.g., a flicker performance of −45 dB) as long as the Source device honors the minimum-to-maximum refresh range even when the Adaptive-Sync SDP payload content is false for one frame during an Adaptive-Sync operation mode transition.

### (3) DPCD Registers Used for Adaptive-Sync

### (3) DPCD Registers Used for Adaptive-Sync

Table 1 below represents Table 2-220: DPCD Registers Used for Adaptive-Sync.

TABLE 1

| | DPCD | |
|---|---|---|
| | Register | |
| Type | Address | Name |
| Capability | 0007h | DOWN_STREAM_PORT_COUNT register, |
| | [6] | MSA_TIMING_PAR_IGNORED bit |
| Extended | 02207h | DOWN_STREAM_PORT_COUNT register, |
| Capability | [6] | MSA_TIMING_PAR_IGNORED bit |
| | 02215h | DPRX_FREATURE_ENUMERATION_LIST_CONT_1 register, |
| | [2, 1, 0] | FAVT_PAYLOAD_FIELDS_PARSING_SUPPORTED, |
| | | AS_SDP_FIRST_HALF_LINE_OR_3840_PIXEL_CYCLE_{—} |
| | | WINDOW_NOT_SUPPORTED, and |
| | | ADAPTIVE_SYNC_SDP_SUPPORTED bits, respectively |
| | 02218h | DPRX_FEATURE_ENUMERATION_LIST_CONT_2 register, |
| | [6] | ADAPTIVE SYNC SDP T2 SUPPORTED IN ALL PR ACTIVE |
| | | STATES bit |
| Configuration | 00107h | DOWNSPREAD_CTRL register, MSA_TIMING_PAR_IGNORE_EN |
| | [7, 6] | and |
| | | FIXED_VTOTAL_AS_SDP_EN_IN_PR_ACTIVE bits |
| | 0011Ah | PANEL REPLAY CONFIGURATION 3 register, |
| | [7:6] | AS_SDP_SETUP_CONFIG_PR_ACTIVE field |
| | 0011Bh | ADAPTIVE_SYNC_SDP_TRANSMISSION_TIMING_CONFIG |
| | [7] | register, |
| | | AS_SDP_ONE_LINE_EARLIER_ENABLE bit |

### Adaptive-Sync Data Block in Adaptive-Sync Operation Related EDID-DisplayID

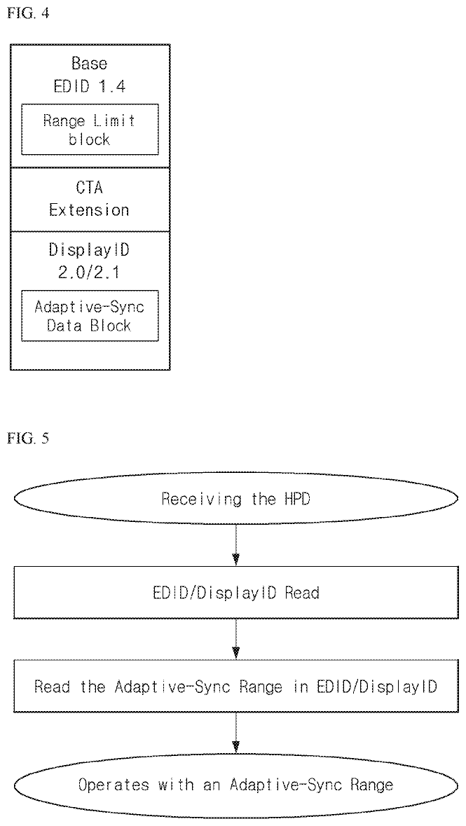

FIG. 4 illustrates an example of an EDID structure that combines an EDID block, a CTA block, and a DisplayID block according to various embodiments of the present disclosure.

Extended Display Identification Data (EDID) is a data structure used by a source device (e.g., GPU) to read information embedded in a sink device (e.g., monitor). When the sink device (e.g., monitor) provides EDID information, the source device (e.g., GPU) may automatically recognize and configure default settings of the sink device (e.g., monitor), such as an optimal resolution and a refresh rate.

The EDID contains information about how the sink device (e.g., monitor) was manufactured, including the manufacturer, model name, manufacturing date, resolution, supported refresh rate, etc. The source device (e.g., GPU) that reads this information may automatically set an optimal resolution and refresh rate of the sink device (e.g., monitor), or the user may manually set them.

The EDID structure may use a combination of EDID block, CTA block, and DisplayID block, and may be configured as an example illustrated in FIG. 4. In addition, since an Adaptive-Sync operation parameters is different for each block, the Sink may display two or more Adaptive-Sync operation parameters to ensure compatibility with the legacy sources.

The EDID is transmitted via a data display channel (DDC). The DDC uses an I²C interface to enable communication between the source device (e.g., GPU) and the sink device (e.g., monitor). The source device (e.g., GPU) requests the EDID information from the sink device (e.g., monitor) via the DDC, and the sink device (e.g., monitor) responds to this.

Currently, in DP2.1, parameters related to the adaptive-Sync operation refer to the information on the adaptive-Sync data block of DisplayID2.0/2.1 in the EDID.

The adaptive-Sync operation parameters for each block may be written in a total of three types of blocks, as described below.

### Adaptive-Sync Data Block in DisplayID 2.0

FIG. 4 illustrates an example of a structure of an Adaptive-Sync Data Block in DisplayID 2.0 according to various embodiments of the present disclosure.

Table 2 below represents Table 4.51: Adaptive-Sync Data Block.

In Table 2, N represents the number of detailed timing descriptors in the data block. M represents the value of offset 01h[6:4]. Source device implementation shall accommodate varying field for future extensibility.

TABLE 2

| Offset | Bit # | Definition/Priority |
|---|---|---|
| 00h | 7:0 | Adaptive-Sync Data Block |
| | | 2Bh |
| 01h | Block Revision and Other Data | |
| | 2:0 | Block Revision |
| | | Revision ranges from 0 through 7 |
| | | 000b = Revision 0 |
| | | All other values are RESERVED |
| | 3 | RESERVED |
| | | Cleared to 0 |
| | 6:4 | Number of Payload Bytes (M) in an Adaptive-Sync Operation |
| | | Mode |
| | | And Range Descriptor |
| | | Where M (bytes) = 6 (initial descriptor size) + field value |
| | | 000b = 6 + 0 bytes/descriptor (defined as part of Adaptive0Sync, |
| | | Revision 0) |
| | | All other values are RESERVED |
| | 7 | RESERVED |
| | | Cleared to 0 |
| 02h | 7:0 | Number of Payload Bytes in Block |
| | | Number of payload bytes within the block is based on the number |
| | | of descriptors (N) * size of each descriptor (M) bytes |
| | | All other values are RESERVED |
| 03h through | (M*8 − 1):0 | First Adaptive-Sync Operation Mode and Range Descriptor |
| 03h + M − 1 | | M-byte descriptor |
| 03h + M through | (M*8 − 1):0 | Second Adaptive-Sync Operation Mode and Range Descriptor |
| 03h + 2M − 1 | | M-byte descriptor, if present |
| . . . | | . . . |
| 03h + (N − 1) * M | (M*8 − 1):0 | Nth Adaptive-Sync Operation Mode and Range Descriptor |
| through | | M-byte descriptor, if present |
| 03h + (N*M) − 1 | | |

Table 3 below represents Table 4.52: Adaptive-Sync Operation Mode and Range Descriptor.

TABLE 3

| Byte # | Bit # | Definition |
|---|---|---|
| 0 | Adaptive-Sync Operation and Range Information | |
| | 0 | Adaptive-Sync Range |
| | | 0 = Non-native panel range. (The display implements buffering to support the declared |
| | | Adaptive-Sync range, and may repeat frames as necessary.) |
| | | 1 = Native panel range. (The display does not implement buffering to support the |
| | | declared Adaptive-Sync range, and does not repeat frames.) |
| | 1 | Successive Frame Duration Increase Tolerance for Meeting VESA Adaptive Sync |
| | | Flicker Performance |
| | | 0) = Flicker performance is met in any duration increase within the refresh rate range, |
| | | but may cause up to a single base video frame period jitter impact. |
| | | 1 = Flicker performance is met in any duration increase within Byte 1. |
| | | Note: Flicker performance is met in any duration increase within the refresh rate range |
| | | without jitter impact when either of the following conditions are met: |

| | |
|---|---|
| (1) | Byte 1 = 00h, -or- |
| (2) | Byte 1 > the delta between the maximum frame duration (=minimum |
| | refresh rate) and the minimum frame duration (=maximum refresh rate) |

| | |
|---|---|
| 3:2 | Supported Adaptive-Sync Modes |
| | 00b = Fixed-Average VTotal (FAVT) mode is supported |
| | 01b = Both Fixed-Average VTotal and Adaptive VTotal modes (FAVT and AVT, |
| | respectively) are supported |
| | All other values are RESERVED |
| 4 | Seamless Transition of Adaptive-Sync Mode and Range Not Supportd |
| | 0 = Seamless transition to and from current Adaptive-Sync mode and range is |
| | supported |
| | 1 = Seamless transition to and from current Adaptive-Sync mode and range is not |
| | supported |
| 5 | Successive Frame Duration Decrease Tolerance for Meeting VESA Adaptive Sync |
| | Flicker Performance |
| | 0 = Flicker performance is met in any duration decrease within the refresh rate range, |
| | but may cause up to a single base video frame period jitter impact |
| | 1 = Flicker performance is met in any duration decrease within Byte 5 |
| | Note: Flicker performance is met in any duration decrease within the refresh rate range |
| | without jitter impact when either of the following conditions are met: |

| | |
|---|---|
| (1) | Byte 5 = 00h, -or- |
| (2) | Byte 5 >= the delta between the maximum frame duration |
| | (=minimum refresh rate) and the minimum frame duration (=maximum |
| | refresh rate) |

| | 7:6 | RESERVED |
|---|---|---|
| | | Cleared to all 0s |
| 1 | 7:0 | Maximum Single Frame Duration Increase Allowed for Meeting VESA Adaptive |
| | | Sync Flicker Performance |
| | | 6.2 format (six integer bits and two fractional bits) that results in a value range of 0.00 |
| | | to 63.75 ms, inclusive |
| | | 00h = Flicker performance is met in any duration increase within the refresh rate range |
| | | without jitter impact |
| 2 | 7:0 | Minimum Refresh Rate |
| | | Minimum refresh rate ranges from 0 through 255 Hz, divided by 1.001 |
| | | 00h = 0 Hz |
| | | 01h = (1/1.001) Hz |
| | | . . . |
| | | FFh = (255/1.001) Hz |
| 4:3 | Maximum Refresh Rate | |
| | Maximum refresh rate ranges from 1 through 1,024 Hz, plus 350 ppm. Note that the value | |
| | stored in this field shall match that of at least one CVT v2.0 RB Timing v3 timing supported | |
| | by the Sink device | |
| | 000h = (1*1.00035) Hz | |
| | . . . | |
| | 3FFh = (1,024 * 1.00035) Hz | |
| 3 | 7:0 | Maximum Refresh Rate 7:0 |
| 4 | 1:0 | Maximum Refresh Rate 9:8 |
| | 7:2 | RESERVED |
| | | Cleared to all 0s |
| 5 | 7:0 | Maximum Single Frame Duration Decrease Allowed for Meeting VESA Adaptive |
| | | Sync Flicker Performance |
| | | 6.2 format (six integer bits and two fractional bits) that results in a value range of 0.00 |
| | | to 63.75 ms, inclusive |
| | | 00h = Flicker performance is met in any duration decrease within the refresh rate range |
| | | without jitter impact |

### Adaptive-Sync SDP

An Adaptive-Sync Second data packet is used for communication between the source device (e.g., GPU) and the sink device (e.g., monitor). The source device (e.g., GPU) sends the Adaptive-Sync Second data packet to the sink device (e.g., monitor), and the sink device (e.g., monitor) receives it and informs the source device (e.g., GPU) of a supported refresh rate range and VRR mode. Based on this information, the source device (e.g., GPU) synchronizes with the sink device (e.g., monitor) to prevent screen tearing, stuttering, etc., and enables smoother screen display. The information and size of the Adaptive-Sync SDP may vary depending on the Adaptive-Sync operation parameter for each EDID block.

Adaptive-Sync SDP operation and information of Header and Payload Data Bytes are as below.

An Adaptive-Sync capable DP protocol converter indicates a support for Adaptive-Sync SDP by setting the ADAPTIVE SYNC SDP SUPPORTED bit in a DPRX_FEATURE_ENUMERATION_LIST_CONT_1 register (DPCD 02214h[0]=1) in addition to setting the MSA_TIMING_PAR_IGNORED bit in a DOWN_STREAM_PORT_COUNT register (DPCD). 00007h[6]=1 and DPCD 02207h[6]=1). The Adaptive-Sync capable DP protocol converter shall support SDP splitting in SST and MST modes and indicate a splitting capability by setting SST_SPLIT_SDP_CAP bits in DPRX_FEATURE_ENUMERATION_LIST register (DPCD 02210h[1]=1). An Adaptive-Sync capable DP source device may enable Adaptive-Sync video transmission to a plugged DP protocol converter only after verifying the following.
(1) The plugged DP protocol converter has DPCD 00007h[6]=1 and DPCD 02214h[0]=1.
(2) A stream sink plugged to a DP protocol converter indicates a support for the Adaptive-Sync refresh rate range in DisplayID or legacy EDID. As is always the case with Adaptive-Sync video transmission, an Adaptive-Sync capable DP source device shall use an AUX write transaction to write 1 to the MSA_TIMING_PAR_IGNORE_EN bit in a DOWNSPREAD_CTRL register (DPCD 00107h[7]=1) before enabling the Adaptive-Sync video transmission. If the plugged DP device has DPCD 02214h[0]=1, a DP source device shall transmit an Adaptive-Sync SDP before enabling an Adaptive-Sync video transmission.

When transmitting the Adaptive-Sync SDP, the DP source device shall do the following:
(3) Transmit an Adaptive-Sync SDP in all video frames. For a multi-field video mode such as interlaced and 3D, the Adaptive-Sync SDP shall be transmitted in all video fields.
(4) Ensure that a start and an end of the Adaptive-Sync SDP transmissions occur within the first half of the line (expressed by a BS symbol sequence) corresponding to a start of a VSync pulse.
(5) transmit valid HTotal[15:0], HStart[15:0], HSyncPolarity[0] (HSP), and HSyncWidth[14:0].

(HSW), VStart[15:0], VSyncPolarity[0] (VSP), and VSyncWidth[14:0] (VSW) is valid HWidth[15:0] and VHeight[15:0] while transmitting the Adaptive-Sync SDP. That is, the Adaptive-Sync capable DP protocol converter shall ignore only VTotal[15:0] while receiving Adaptive-Sync SDP.

An Adaptive-Sync-capable DP protocol converter shall indicate Adaptive-Sync SDP by setting the ADAPTIVE SYNC SDP SUPPORTED bit in the support DPRX_FEATURE_ENUMERATION_LIST_CONT_1 register (DPCD 02214h[0]=1) in addition to setting the MSA_TIMING_PAR_IGNORED bit in the DOWN_STREAM_PORT_COUNT register(s) (DPCD 00007h[6]=1 and DPCD 02207h[6]=1). An Adaptive-Sync-capable DP protocol converter shall support SDP splitting in SST and MST modes, and indicates its splitting capability by setting the SST_SPLIT_SDP_CAP bit in the DPRX_FEATURE_ENUMERATION_LIST register (DPCD 02210h[1]=1). An Adaptive-Sync-capable DP Source device may enable an Adaptive-Syne video transmission to a plugged DP protocol converter only after verifying the following:
(1) Plugged DP protocol converter has DPCD 00007h[6]=1 and DPCD 02214h[0]=1
(2) Stream sink plugged to the DP protocol converter indicates support for the Adaptive-Sync refresh rate range in the DisplayID or legacy EDID As is always the case with Adaptive-Sync video transmission, an Adaptive-Sync-capable DP Source device shall use an AUX write transaction to write 1 t to the MSA_TIMING_PAR_IGNORE_EN bit in the DOWNSPREAD_CTRL register (DPCD 00107h[7]=1) prior to enabling an Adaptive-Sync video transmission. When the plugged DP device has DPCD 02214h[0]=1, a DP Source device shall transmit an Adaptive-Sync SDP before enabling an Adaptive-Sync video transmission.

When transmitting an Adaptive-Sync SDP, a DP Source device shall do the following:
(3) Transmit an Adaptive-Sync SDP on every video frame. For multi-field video modes such as Interlaced and 3D, the Adaptive-Sync SDP shall be transmitted on every video field.
(4) Ensure that the start and end of the Adaptive-Sync SDP transmission occur within the 1st half of the line (marked by BS symbol sequences) that corresponds to the start of the VSync pulse.
(5) Transmit valid HTotal[15:0], HStart[15:0], HSyncPolarity[0] (HSP), HSyncWidth[14:0]

(HSW), VStart[15:0], VSyncPolarity[0] (VSP), and VSyncWidth[14:0] (VSW) while transmitting an Adaptive-Sync SDP, as well as valid HWidth[15:0] and VHeight[15:0]. That is, an Adaptive-Sync-capable DP protocol converter shall ignore only VTotal[15:0] while receiving an Adaptive-Sync SDP.

Table 4 represents Table 2-126: Adaptive-Sync SDP Header Bytes

TABLE 4

| Byte # | Bit # | Content |
|---|---|---|
| HB0 | 7:0 | Secondary-data Packet ID |
| | | Specific to stream (usually 00h) |
| HB1 | 7:0 | Secondary-data Packet Type |
| | | 22h = Adaptive-Sync |
| HB2 | 4:0 | Version Number |
| | | 01h = Version 1. No payload data bytes (same as DP v2.0, as released in June |
| | | 2019). |
| | | 02h = Version 2. VESA AdaptiveSync shall support both the Display ID Adaptive- |
| | | Sync data block and Adaptive-Sync SDP data structure version 2. |
| | | All other values are RESERVED for future versions. |
| | 7:5 | RESERVED |
| | | Read all 0s |
| HB3 | 5:0 | Number of Valid Data Bytes |
| | | Version 1 |
| | | 00h = No payload data bytes. |
| | | Version 2 |
| | | 09h = Nine payload data bytes. |
| | | The Adaptive-Sync SDP has 32 payload data bytes. Unused data bytes shall be |
| | | zero-padded. |
| | 7:6 | RESERVED |
| | | Read all 0s. |

Table 5 represents Table 2-127: Adaptive-Sync SDP Version 2 Payload Data Bytes.

TABLE 5

| Byte # | Bit # | Content |
|---|---|---|
| DB0 | Timing Options | |
| | 0 | VARIABLE_FRAME_RATE_DISABLE |
| | 1 | Adaptive Sync Operation Mode |
| | | When a Source device sets the MSA_TIMING_PAR_IGNORE_EN and |
| | | FIXED_VTOTAL_AS_SDP_EN_IN_PR_ACTIVE bits in the |
| | | DOWNSPREAD_CTRL register (DPCD 00107h [7, 6] = 11b, respectively): |
| | | 00b = AVT mode, and video frame duration is bound to change from frame-to- |
| | | frame. |
| | | 01b = AVT mode; however, video frame duration is currently fixed. |
| | | 10b = FAVT mode, and TRR is yet to be reached. |
| | | 11b = FAVT mode, and TRR is reached. |
| | | When a Source device programs DPCD 00107h[7, 6] = 01b (see Section 2.18 for |
| | | details): |
| | | 01b = Adaptive-Sync operation is disabled and the VTotal line count is fixed. |
| | | 00b, 10b, and 11b = RESERVED. |
| | 2 | Adaptive Sync SDP Transmission Disable in PR Active State |
| | | Cleared to 0 when the Sink device does not support PR. |
| | | 0 = Source-to-Sink device timing sync using the Adaptive-Sync SDP is enabled. |
| | | 1 = Source-to-Sink device timing sync using the Adaptive-Sync SDP is disabled. |
| | 3 | Remote Frame Buffer (RFB) Update in PR Active State |
| | | Valid only during a PR Active state. Shall be driven to 0 in PR_State 0_0 (Disabled) |
| | | -or- |
| | | PR_State 0_1 (Inactive). Cleared to 0 when the Sink device does not support PR. |
| | | 0 = No RFB update in the current active video image time interval. |
| | | 1 = Update the RFB - Capture the incoming video frame/Sus to the RFB. |
| | 7:4 | RESERVED |
| | | Read all 0s. |
| DB1 | 7:0 | Minimum Vertical Total7:0 |
| DB2 | 7:0 | Minimum Vertical Total15:8 |
| | | Source device shall program DB2:DB1 to the VTotal value that corresponds to the |
| | | enabled base timing. The value is statically programmed and is valid in both FAVT |
| | | mode and AVT mode. |
| DB3 | 7:0 | Target Refresh Rate7:0 |
| DB4 | 1:0 | Target Refresh Rate9:8 |
| | | AVT mode |
| | | Source device shall clear DB4[1:0] = 00b and DB3 = 00h. |
| | | FAVT mode |
| | | Source device shall program DB4[1:0] and DB3 and DV4[5] to match the average |
| | | video frame rate. |
| | 4:2 | RESERVED |
| | | Read all 0s. |
| | 5 | Target Refresh Rate Divider |
| | | Valid only in FAVT mode. Sink device ignores the bit in AVT mode. |
| | | 0 = 1.000. |
| | | 1 = 1.001. |
| | 6 | Successive Frame Duration Increase Configuration |
| | | If the Source device engages in a bounded transition for low-flicker performance |
| | | by using information in the DisplayID Adaptive-Sync data block and setting this |
| | | bit to 1, the Source device shall: |

| | |
|---|---|
| (1) | Use the CVT v2.0 RB Timing v3 -or- detailed timing descriptor with 350- |
| | ppm offset exposed in the Display ID, and |
| (2) | Constrain the duration increase to the value reported in the DisplayID |
| | Adaptive-Sync data block for a guarantee of low-flicker performance |

| | |
|---|---|
| | 0 = Video frame duration increase transitions are unbounded. |
| | 1 = Video frame duration increase transitions are bounded by the time specified in |
| | DB5. |
| 7 | Successive Frame Duration Decrease Configuration |
| | If the Source device engages in a bounded transition for low-flicker performance |
| | by using the information in the DisplayID Adaptive-Sync data block and setting |
| | this bit to 1, the Source device shall: |

| | |
|---|---|
| (1) | Use the CVT v2.0 RB Timing v3 -or- detailed timing descriptor with 350- |
| | ppm offset exposed in the Display ID, and |
| (2) | Constrain the duration decrease to the value reported in the Display ID |
| | Adaptive-Sync data block for a guarantee of low-flicker performance |

| | | |
|---|---|---|
| | | 0 = Video frame duration decrease transitions are unbounded. |
| | | 1 = Video frame duration decrease transitions are bounded by the time specified in |
| | | DB6. |
| DB5 | 7:0 | Duration Increase Constraint Value in ms Unit |
| | | 6.2 format (six integer bits and two fractional bits) that results in a value range of |
| | | 0.00 to 63.75 ms, inclusive. |
| | | When the Source device clears DB4[6] = 0, the Source device shall clear DB5 = |
| | | 00h |
| | | When the Source device sets DV4[6] = 1, the Source device shall program DB5 to |
| | | the value that the Source device is using for the maximum duration increase. The |
| | | value does not indicate the instantaneous video frame-to-frame duration delta. |
| | | A 0.00 value indicates that the Source device may invoke a maximum-to-minimum |
| | | refresh rate transition across a single video frame boundary. |
| | | To attain optimum flicker performance without jitter impact, the Source device |
| | | shall keep the DB5 value less than or equal to the limit value reported by the Sink |
| | | device in the Max Single Frame Duration Increase Allowed for Attaining the Low |
| | | Flicker Performance byte (Byte 1) of the DisplayID Adaptive-Sync data block's |
| | | Operation Mode and Range descriptor. |
| DB6 | 7:0 | Duration Decrease Constraint Value in ms Unit |
| | | 6.2 format (six integer bits and two fractional bits) that results in a value range of |
| | | 0.00 to 63.75 ms, inclusive. |
| | | When the Source device clears DB4[7] = 0, the Source device shall clear DB6 = |
| | | 00h. |
| | | When the Source device sets DB4[7] = 1, the Source device shall program DB6 to |
| | | the value that the Source device is using for the maximum duration decrease. The |
| | | value does not indicate the instantaneous video frame-to-frame duration delta. |
| | | A 0.00 value indicates that the Source device may invoke a maximum-to-minimum |
| | | refresh rate transition across a single video frame boundary. |
| | | To attain optimum flicker performance without jitter impact, the Source device |
| | | shall keep the DB6 value less than or equal to the limit value reported by the Sink |
| | | device in the Max Single Frame Duration Decrease Allowed for Attaining the Low |
| | | Flicker Performance byte (Byte 5) of the DisplayID Adaptive-Sync data block's |
| | | Operation Mode and Range descriptor. |
| DB7 | 7:0 | Coasting VTotal7:0 in PR Active State |
| | | Shall be programmed to the Coasting Vtotal LSB value that the Sink device shall |
| | | use to maintain the refresh rate when the DPTX has suspended transmission of the |
| | | Adaptive-Sync SDP in a PR Active state. |
| | | DB7 = 00h when the Sink device does not support PR. |
| DB8 | 7:0 | Coasting VTotall15:8 in PR Active State |
| | | Shall be programmed to the Coasting VTotal MSB value that the Sink device shall |
| | | use to maintain the refresh rate when the DPTX has suspended transmission of the |
| | | Adpative-Sync SDP in a PR Active state. |
| | | DB8 = 00h when the Sink device does not support PR. |
| DB9 | 191:0 | RESERVED |
| through | | Read all 0s. |
| DB31 | | |

### OverDrive/Overdrive Table

### OverDrive

OverDrive is a technology used in a sink device (e.g., monitor). The OverDrive can minimize motion blur by increasing a pixel switching speed and reduce screen flicker by increasing a response time. The OverDrive in the sink device (e.g., monitor) can be generally controlled by a built-in controller, and users can adjust it in the settings menu of the sink device (e.g., monitor).

The OverDrive is frequently used in the sink device (e.g., monitor). The sink device (e.g., monitor) has a fixed response time, which may cause motion blur when a high-speed moving object appears on the screen. To address this issue, the OverDrive minimizes the motion blur by increasing the pixel switching speed and reduces the screen flicker by increasing the response time. However, excessive setting of the OverDrive may cause juddering when the high-speed moving object passes by on the screen. To address this issue, appropriate OverDrive setting is necessary.

### Overdrive Table

An Overdrive Table is a function provided by the manufacturer of a sink device (e.g., monitor) and serves as a reference when adjusting the Overdrive function of the sink device (e.g., monitor). The Overdrive table may be generally downloaded from the manufacturer's website, allowing users to appropriately adjust the Overdrive function of the sink device (e.g., monitor) to achieve optimal screen performance.

The Overdrive table is provided with the model name of the sink device (e.g., monitor), and each model offers various Overdrive options. The users can adjust the overdrive settings of the sink device (e.g., monitor) by referring to the Overdrive table, thereby minimizing problems, such as screen shaking and motion blur, and achieving optimal screen performance.

However, there are some cautions to using the Overdrive table. Because the Overdrive tables of all the sink devices (e.g., monitors) do not operate identically, the users shall refer to the Overdrive table for each model and select the appropriate setting.

### Problems of the Related Art

The DisplayPort standard limits a transfer rate based on supported resolutions and whether to use display stream compression (DSC), and thus an adaptive-Sync frame range differently operates in response to this. (see Example 1 below) Accordingly, a multi-frame adaptive-Sync range shall be written in EDID, and in this case, proper rules are required for correct operation. However, no appropriate rules for operating multi-frame adaptive-Sync have been defined to date.

As described in Example 2 below, when the adaptive-Sync frame range is set from 60 Hz to 240 Hz, an adaptive-Sync mode operates at 120 Hz not 240 Hz, which is a max frame range. If OverDrive is tuned to 240 Hz, excessive Over/Undershoot may occur when the adaptive-Sync mode operates at 120 Hz which is not tuned. When the OverDrive tuning based on the frame range is performed in a sink device (e.g., monitor) applying the adaptive-Sync technology, the tuning is performed based on the max frame range. Because the tuning is not performed at frequencies lower than the max frame range (the tuning is performed only in the max frame range), excessive Over/Undershoot occurs, leading to a problem.

Therefore, standardized regulations are required between a source device and the sink device that refer to only the max value of the frame range, so that the multi-frame adaptive-Sync properly operates. If this standardization is achieved, an adaptive-Sync-supporting device can automatically configure multi-frame adaptive-Sync and achieve optimal performance.

### Example 1

(Example 1-1) Support a max frame rate based on a resolution when UHBR20 is supported in, for example, Display Port 2.1

=10K (10240×4320) @60 Hz and 24 bpp 4:4:4 (no compression)→11000×4500×60×1.03×24=73.418 Gbps

=8K (7680×4320) @80 Hz and 24 bpp 4:4:4 (no compression)→8800×4500×80×1.03×24=78,312 Gbps

=5K (5120×2160) @260 Hz and 24 bpp 4:4:4 (no compression)→5500×2250×260×1.03×24=79.536 Gbps

(Example 1-2) Support a max frame rate based on the use of DSC when UHBR20 is supported in, for example, Display Port 2.1

=[10K (10240×4320) @60 Hz (no compression)/10K (10240×4320) @180 Hz (DSC 1.2a)] and 24 bpp 4:4:4

=[8K (7680×4320) @80 Hz (no compression)/8K (7680×4320) @240 Hz (DSC 1.2a)] and 24 bpp 4:4:4

=[5K (5120×2880) @260 Hz (no compression)/5K (5120×2880) @780 Hz (DSC 1.2a)] and 24 bpp 4:4:4

If the frame ranges currently supported by the sink device are written in EDID, the source device operates only within this range, as described in Example 2 below.

### Example 2

### [Video Timing]

Video Timing1: 4 k@240 hz
Video Timing2: 4 k@120 hz
Video Timing3: 4 k@100 hz

### [Frame Range]

Adaptive-Sync Frame Range1: 40 hz-120 hz
Adaptive-Sync Frame Range2: 60 hz-240 hz
Adaptive-Sync Frame Range3: 24 hz-100 hz

### [Use Case]

When the user uses T0, the source only has 1 choice. The user gets adaptive-Sync operation from 60 hz-240 hz.

When the user uses T1, the source has 2 choices as 120 Hz fits into both D1 and D2. The highest refresh rate is always T1's 120 Hz, but lowest refresh rate is changing base on the descriptor source choose.
When the source use D1, the user gets adaptive-Sync operation from 40 hz-120 hz.
When the source uses D2, the user gets adaptive-Sync operation from 60 hz-120 hz.

When the user uses T2, the source has 3 choices as 100 hz fits all 3 range descriptors. The highest refresh rate is always T2's 100 hz, but the lowest refresh rate is changing base on the descriptor source choose.
When the source use D1, the user gets adaptive-Sync operation from 40 hz-100 hz.
When the source uses D2, the user gets adaptive-Sync operation from 60 hz-100 hz.
When the source uses D3, the user gets adaptive-Sync operation from 24 hz-100 hz.

When the user uses T3, the source has 2 choices as 50 hz is out of D2. The highest refresh rate is always T3's 50 hz, but the lowest refresh rate is changing base on the descriptor source choose.
When the source use D1, the user gets adaptive-Sync operation from 40 hz-50 hz.
When the source uses D3, the user gets adaptive-Sync operation from 24 hz-50 hz.

### [Video Timing]

Video Timing1: 4 k@240 hz
Video Timing2: 4 k@120 hz
Video Timing3: 4 k@100 hz

### [Frame Range]

Adaptive-Sync Frame Range1: 40 hz-120 hz
Adaptive-Sync Frame Range2: 60 hz-240 hz
Adaptive-Sync Frame Range3: 24 hz-100 hz

### [Use Case]

When user uses T0, source only has 1 choice. user gets Adaptive-Sync operation from 60 hz-240 hz.

When user uses T1, source has 2 choices as 120 hz fits into both D1 & D2. The highest refresh rate is always T1's 120 hz, but lowest refresh rate is changing base on the descriptor source choose.
When source use D1, user gets Adaptive-Sync operation from 40 hz-120 hz.
When source uses D2, user gets Adaptive-Sync operation from 60 hz-120 hz.

When user uses T2, source has 3 choices as 100 hz fits all 3 range descriptors. The highest refresh rate is always T2's 100 hz, but lowest refresh rate is changing base on the descriptor source choose.
When source use D1, user gets Adaptive-Sync operation from 40 hz-100 hz.
When source uses D2, user gets Adaptive-Sync operation from 60 hz-100 hz.
When source uses D3, user gets Adaptive-Sync operation from 24 hz-100 hz.

When user uses T3, source has 2 choices as 50 hz is out of D2. The highest refresh rate is always T3's 50 hz, but lowest refresh rate is changing base on the descriptor source choose.
When source use D1, user gets Adaptive-Sync operation from 40 hz-50 hz.
When source uses D3, user gets Adaptive-Sync operation from 24 hz-50 hz.

### Composition and Operation of the Invention

An object of various embodiments of the present disclosure is to provide a method and device for writing a sink EDID multi-frame range to ensure compatibility between devices supporting Multi Adaptive-Sync (multiple frame ranges), and a method and device for setting an adaptive-Sync frame range of a source device. Another object of various embodiments of the present disclosure is to provide a method and device that optimizes the picture quality and performance of a sink device (e.g., a monitor) by establishing requirements for properly operating an adaptive-Sync operation, thereby enabling a user to enjoy a comfortable gaming and video playback experience.

### Operation of Source Device

When using an adaptive-Sync function, a source device operates using a frame rate of the selected video timing and a frame range matching a maximum frame among frame ranges defined in an Adaptive-Sync data block.

### Example 3

### [Video Timing]

Video Timing1: 4 k@240 hz
Video Timing2: 4 k@120 hz
Video Timing3: 4 k@100 hz

### [Frame Range]

Adaptive-Sync Frame Range1: 40 hz-120 hz
Adaptive-Sync Frame Range2: 60 hz-240 hz
Adaptive-Sync Frame Range3: 24 hz-100 hz

### [Use Case]

1. When video timing is selected as 4 k@240 hz in OS, it operates at 60 hz-240 hz using Adaptive-Sync Frame Range2.

2. When video timing is selected as 4 k@120 hz in OS, it operates at 40 hz-120 hz using Adaptive-Sync Frame Range1.

3. When video timing is selected as 4 k@100 hz in OS, it operates at 24 hz-100 hz using Adaptive-Sync Frame Range3.

### Operation of Sink Device

If a sink device uses a multi-frame rate, the sink device shall write a frame rate of video timing and a maximum value of an adaptive-Sync frame range in EDID so that they match. Further, Overdrive tuning shall be performed for each frame range. In this case, tuning of the optimal Overdrive value for each frame range can prevent excessive Over/Undershoot and improve the screen quality.

FIG. 5 illustrates an example of a process for determining a frame range when a source device performs adaptive-Sync operation.

FIG. 5 illustrates an embodiment when only a single adaptive-Sync data block range is supported.

Referring to FIG. 5, a source device receives a hot plug detection (HPD) from a sink device.

The source device receives extended display identification data (EDID)/DisplayID (DPID) from the sink device and identifies them. That is, the source device reads extended display identification data (EDID)/DisplayID (DPID) of the sink device.

The source device identifies an adaptive sync range supported by the sink device from the received EDID/DPID. That is, the source device reads the adaptive sync range from the EDID/DPID.

The source device operates with the adaptive sync range. That is, the source device processes audio/video signal based on the adaptive sync range and transmits it to the sink device.

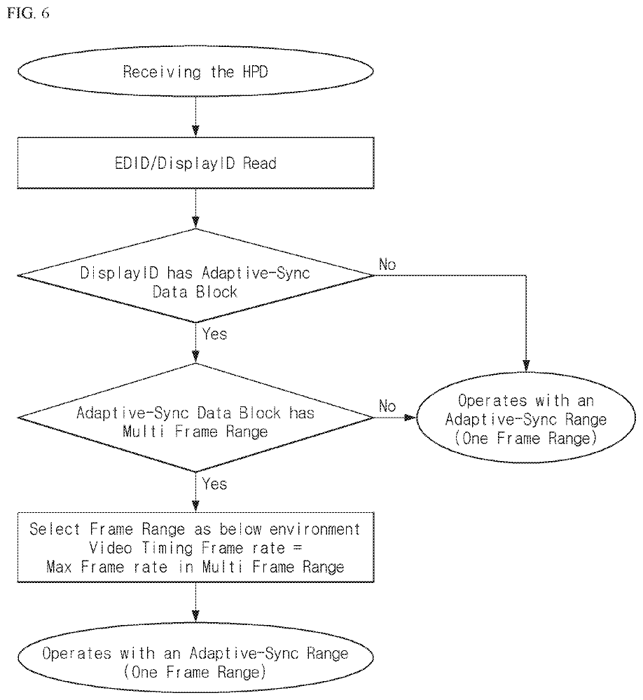

FIG. 6 illustrates an example of a process for determining a frame range when a source device according to various embodiments of the present disclosure performs adaptive-Sync operation.

FIG. 6 illustrates an embodiment when a plurality of adaptive-Sync data block ranges are supported.

Referring to FIG. 6, a source device receives extended display identification data (EDID)/DisplayID (DPID) from a sink device and identifies them. That is, the source device reads extended display identification data (EDID)/DisplayID (DPID) of the sink device.

The source device determines whether an adaptive-Sync data block is present in the received EDID/DPID.

If the adaptive-Sync data block is present in the received EDID/DPID, the source device determines whether multiple (i.e., a plurality of) adaptive-Sync data block ranges are present in the adaptive-Sync data block.

If the multiple (i.e., the plurality of) adaptive-Sync data block ranges are present in the adaptive-Sync data block, the source device selects a frame range based on an environment where a video timing frame rate matches a maximum frame rate of a multi-frame range.

Based on the selected frame range, the source device operates with an adaptive-Sync range (one Frame Range). That is, the source device processes audio/video signal based on the selected adaptive-Sync range and transmits it to the sink device.

If the adaptive-Sync data block is not present in the EDID/DPID, or if the multiple (i.e., the plurality of) adaptive-Sync data block ranges are not present in the adaptive-Sync data block (i.e., if only one adaptive-Sync data block range is present in the adaptive-Sync data block), the source device operates with one adaptive-Sync range. That is, the source device processes the audio/video signal based on the one adaptive-Sync range and transmits it to the sink device.

### Method of Writing Frame Range in EDID if a Sink Device of the Present Disclosure Supports Multiple Adaptive-Sync Ranges

A sink device supporting a multi adaptive-Sync range writes video timing and a maximum value of an adaptive-Sync range in EDID by matching them. In addition, Overdrive tuning is performed for each adaptive-Sync frame range to prevent excessive Over/Undershoot from occurring regardless of which adaptive-Sync frame range area a source device selects.

### Example 4

If [Video Timing] is written in EDID as follows,
Video Timing1: 4 k@240 hz
Video Timing2: 4 k@120 hz
Video Timing3: 4 k@100 hz

The [Frame Range] shall be set to match the adaptive-Sync range with the Max value by referring to the Video Timing and written in EDID as follows.
Adaptive-Sync Frame Range1: 40 hz-240 hz
Adaptive-Sync Frame Range2: 60 hz-120 hz
Adaptive-Sync Frame Range3: 24 hz-100 hz

The manufacturer of the sink device tunes the OverDrive in each ‘40 hz-120 hz’, ‘60 hz-240 hz’, and ‘24 hz-100 hz’ Frame Range as indicated in the EDID as above, and differently takes the OverDrive Table for each Frame Range.

### DESCRIPTION OF CLAIMS RELATED TO SOURCE DEVICE

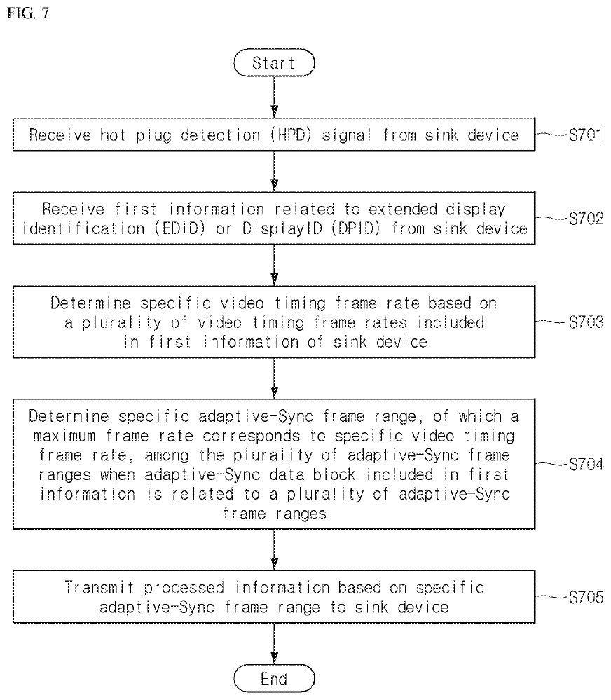

Below, the above-described embodiments are described in detail from an operation perspective of a UE with reference to FIG. 7. Methods to be described below are merely distinguished for convenience of explanation. Thus, as long as the methods are not mutually exclusive, it is obvious that partial configuration of any method can be substituted or combined with partial configuration of another method.

FIG. 7 illustrates an example of an operation process of a source device according to various embodiments of the present disclosure.

According to various embodiments of the present disclosure, there is provided a method performed by a source device.

The source device includes a processor, a memory, and a transceiver. The memory stores instructions performing operations based on being executed by the processor.

In step S701, the source device receives a hot plug detection (HPD) signal from a sink device.

In step S702, the source device receives first information related to an extended display identification (EDID) or DisplayID (DPID) from the sink device.

In step S703, the source device determines a specific video timing frame rate based on a plurality of video timing frame rates included in the first information of the sink device.

In step S704, if an adaptive-Sync data block included in the first information is related to a plurality of adaptive-Sync frame ranges, the source device determines a specific adaptive-Sync frame range, of which a maximum frame rate corresponds to the specific video timing frame rate, among the plurality of adaptive-Sync frame ranges.

In step S705, the source device transmits processed information based on the specific adaptive-Sync frame range to the sink device.

According to various embodiments of the present disclosure, if the number of adaptive-Sync frame ranges, to which the adaptive-Sync data block is related, is 1, the specific adaptive-Sync frame range may be determined as one adaptive-Sync frame range to which the adaptive-Sync data block is related.

According to various embodiments of the present disclosure, if the first information includes display stream compression (DSC) information, the specific video timing frame rate may be determined among the plurality of video timing frame rates or multiple video timing frame rates.

According to various embodiments of the present disclosure, the multiple video timing frame rates may be generated by applying DSC to the plurality of video timing frame rates.

According to various embodiments of the present disclosure, the maximum frame rate of the specific adaptive-Sync frame range may be the same as the specific video timing frame rate.

According to various embodiments of the present disclosure, the specific video timing frame rate may be determined by input information to the source device or by an arbitrary selection by the source device.

According to various embodiments of the present disclosure, the specific adaptive-Sync frame range may be determined based on the specific video timing frame rate.

According to various embodiments of the present disclosure, the processed information may be based on tuning of an overdrive value for the specific adaptive-Sync frame range.

According to various embodiments of the present disclosure, there is provided a source device. The source device may include a processor, a memory, and a transceiver, and the processor may be configured to perform the operation method of the source device based on FIG. 7.

According to various embodiments of the present disclosure, there is provided a device controlling a source device. The device may include at least one processor and at least one memory operably connected to the at least one processor. The at least one memory may be configured to store instructions performing the operation method of the source device based on FIG. 7 based on being executed by the at least one processor.

According to various embodiments of the present disclosure, there are provided one or more non-transitory computer readable mediums storing one or more instructions. The one or more instructions may perform operations based on being executed by one or more processors, and the operations may include the operation method of the source device based on FIG. 7.

The claims described in various embodiments of the present disclosure can be combined in various ways. For example, technical features of the method claims of various embodiments of the present disclosure can be combined and implemented as a device, and technical features of the device claims of various embodiments of the present disclosure can be combined and implemented as a method. In addition, the technical features of the method claims and the technical features of the device claims in various embodiments of the present disclosure can be combined and implemented as a device, and the technical features of the method claims and the technical features of the device claims in various embodiments of the present disclosure can be combined and implemented as a method.

1. A method of operating a source device, the method comprising:
receiving a hot plug detection (HPD) signal from a sink device;
receiving first information related to an extended display identification (EDID) or a Display ID (DPID) from the sink device;
determining a specific video timing frame rate based on a plurality of video timing frame rates included in the first information of the sink device;
based on an adaptive-Sync data block included in the first information being related to a plurality of adaptive-Sync frame ranges, determining a specific adaptive-Sync frame range, of which a maximum frame rate is related to the specific video timing frame rate, among the plurality of adaptive-Sync frame ranges; and
transmitting processed information based on the specific adaptive-Sync frame range to the sink device.

2. The method of claim 1, wherein based on a number of adaptive-Sync frame ranges to which the adaptive-Sync data block is related being 1, the specific adaptive-Sync frame range is determined as one adaptive-Sync frame range to which the adaptive-Sync data block is related.

3. The method of claim 1, wherein based on display stream compression (DSC) information being included in the first information, the specific video timing frame rate is determined among the plurality of video timing frame rates or multiple video timing frame rates, and
wherein the multiple video timing frame rates are generated by applying a DSC to the plurality of video timing frame rates.

4. The method of claim 1, wherein the maximum frame rate of the specific adaptive-Sync frame range is the same as the specific video timing frame rate.

5. The method of claim 1, wherein the specific video timing frame rate is determined by input information to the source device or by an arbitrary selection by the source device.

6. The method of claim 1, wherein the specific adaptive-Sync frame range is determined based on the specific video timing frame rate.

7. The method of claim 1, wherein the processed information is based on tuning of an overdrive value for the specific adaptive-Sync frame range.

8. A source device comprising:
a processor;
a memory; and
a transceiver,
wherein the memory stores instructions performing operations based on being executed by the processor,
wherein the operations comprise:
receiving a hot plug detection (HPD) signal from a sink device;
receiving first information related to an extended display identification (EDID) or a DisplayID (DPID) from the sink device;
determining a specific video timing frame rate based on a plurality of video timing frame rates included in the first information of the sink device;
based on an adaptive-Sync data block included in the first information being related to a plurality of adaptive-Sync frame ranges, determining a specific adaptive-Sync frame range, of which a maximum frame rate is related to the specific video timing frame rate, among the plurality of adaptive-Sync frame ranges; and
transmitting processed information based on the specific adaptive-Sync frame range to the sink device.

9. The source device of claim 8, wherein based on a number of adaptive-Sync frame ranges to which the adaptive-Sync data block is related being 1, the specific adaptive-Sync frame range is determined as one adaptive-Sync frame range to which the adaptive-Sync data block is related.

10. The source device of claim 8, wherein based on display stream compression (DSC) information being included in the first information, the specific video timing frame rate is determined among the plurality of video timing frame rates or multiple video timing frame rates, and
wherein the multiple video timing frame rates are generated by applying a DSC to the plurality of video timing frame rates.

11. The source device of claim 8, wherein the maximum frame rate of the specific adaptive-Sync frame range is the same as the specific video timing frame rate.

12. The source device of claim 8, wherein the specific video timing frame rate is determined by input information to the source device or by an arbitrary selection by the source device.

13. The source device of claim 8, wherein the specific adaptive-Sync frame range is determined based on the specific video timing frame rate.

14. The source device of claim 8, wherein the processed information is based on tuning of an overdrive value for the specific adaptive-Sync frame range.

15. One or more non-transitory computer readable mediums storing one or more instructions,
wherein the one or more instructions perform operations based on being executed by one or more processors,
wherein the operations comprise:
receiving a hot plug detection (HPD) signal from a sink device;
receiving first information related to an extended display identification (EDID) or a DisplayID (DPID) from the sink device;
determining a specific video timing frame rate based on a plurality of video timing frame rates included in the first information of the sink device;
based on an adaptive-Sync data block included in the first information being related to a plurality of adaptive-Sync frame ranges, determining a specific adaptive-Sync frame range, of which a maximum frame rate is related to the specific video timing frame rate, among the plurality of adaptive-Sync frame ranges; and
transmitting processed information based on the specific adaptive-Sync frame range to the sink device.
